(19) United States
(12) Patent Application Publication
(10) Pub. No.: US 2010/0253955 A1
(43) Pub. Date: Oct. 7, 2010

(54) Recording Control Device, Recording System, and Recording Control Method

(75) Inventor: Masahiro Murata, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: SEIKO EPSON CORPORATION, Tokyo (JP)

(21) Appl. No.: 12/751,604

(22) Filed: Mar. 31, 2010

(30) Foreign Application Priority Data
Apr. 7, 2009 (JP) 2009-092829

(51) Int. Cl. H04N 1/60

(52) U.S. Cl. 358/1.9

(57) ABSTRACT

A recording control device can adjust the recording density without causing color shifting when recording images using chromatic and achromatic inks. A host computer 2 is connected to a printer 3 that records on a recording medium using the four ink colors CMYK, and has a printer driver 10 that converts an image to be recorded to ink volume values using a lookup table for converting coordinate values of an input color model to ink volume values in a CMYK ink color model, and causes the printer 3 to record the image to be recorded according to this ink volume information. When the black dot recording density for parts that are printed on the recording medium using black and the color recording density of parts that are printed a chromatic color are set, the printer driver 10 generates a new lookup table based on these set density values and values in a lookup table, and causes the printer 3 to print based on the resulting new lookup table.

### CROSS-REFERENCE TO RELATED APPLICATION

Japanese Patent application No. 2009-092829 is hereby incorporated by reference in its entirety.

### BACKGROUND

1. Field of Invention

The present invention relates to a recording control device, a recording system, and a recording control method for controlling a recording device that records using chromatic and achromatic inks.

2. Description of Related Art

Technology enabling adjusting the density of an image to be printed by a recording device that prints using a cyan (C), magenta (M), yellow (Y), and black (K) ink set is known from the literature. See, for example, Japanese Unexamined Patent Appl. Pub. JP-A-2002-199236. More specifically, JP-A-2002-199236 teaches technology for converting image data in the RGB color space to a CMY color space, then converting to the CMYK color space corresponding to the four color ink set used by the recording device, and finally adjusting to the specified density.

However, when the density is adjusted after conversion to the CMYK color space, quantization error and other types of error occur in the operations executed to adjust the density, thus slightly disrupting the balance between the color ink quantities and possibly introducing a color shift. This is particularly a problem if the change in the balance between the different colors of ink produces a color shift in composite black, which is created by mixing chromatic CMY inks to render black, because there will be a pronounced difference between this composite black and blacks recorded using black ink.

In addition, if the density is adjusted after converting the image data to the CMYK color space as described in JP-A-2002-199236, the image data itself must be corrected. Because the image data is typically quite large, this increases the processing load and requires more time.

In addition, if the density of composite black rendered using CMY inks and the density of black rendered using black (K) ink can be individually adjusted, the density of the composite black and the density of the black (K) ink are preferably adjusted separately because of the greater freedom allowed in adjusting the density.

### SUMMARY OF INVENTION

A recording control device, a recording system, and a recording control method according to the present invention enable adjusting the recording density by means of a low load process that can be executed quickly without causing color shifting when recording images using chromatic and achromatic inks.

A recording control device, a recording system, and a recording control method according to another aspect of the present invention enable adjusting the density of different colors of ink with a high degree of freedom.

A first aspect of the invention is a recording control device that is connected to and controls a recording device that records on a recording medium using chromatic and achromatic inks, the recording control device including a recording control unit that converts an image to be recorded to ink volume information using a lookup table for converting coordinate values of an input color model to ink volume information of an ink color model composed of a plurality of ink types including achromatic ink and chromatic ink, and causes the recording device to record the image to be recorded according to this ink volume information. When a recording density for parts that are recorded on the recording medium using an achromatic color and a recording density for parts that are recorded using a chromatic color are set, the recording control unit produces a new lookup table based on these set density values and the values in the lookup table, and causes the recording device to record based on the produced new lookup table.

When the density of parts that are recorded using an achromatic color and the recording density of parts that are recorded using a chromatic color are set, this aspect of the invention generates a new lookup table based on these set values and records the image to be recorded using this new lookup table. As a result, the image can be quickly recorded according to the recording density settings without disturbing the balance between the different colors of ink.

In addition, because a lookup table is produced based on the density setting of the parts recorded in an achromatic color and the recording density setting of parts that are recorded in a chromatic color, the achromatic ink density can be adjusted appropriately and achromatic ink can be effectively used to record images even after adjusting the density.

Yet further, because a new lookup table for converting the image to an ink color space is produced, color shifts do not occur as easily as in a configuration that adjusts images in the input color model or adjusts the image after the image is converted using a lookup table.

Yet further, the load of the process for generating a new lookup table is less than the load of a process for correcting the image itself after conversion, and the density of the image can be quickly adjusted by converting the image using this newly produced lookup table.

In addition, the ink volume values that are used when producing the new lookup table can be set with a high degree of freedom, and the density of individual CMYK colors can be adjusted if the lookup table is a table for converting the coordinate values of the input color model to the ink volume values of the four CMYK colors. As a result, the density of composite black rendered using CMY inks and the density of black (K) ink can be separately adjusted as ink volume values for recording black, and the density of each color of ink can be adjusted with a high degree of freedom.

In another aspect of the invention, when an achromatic recording density for parts that are recorded on the recording medium using an achromatic color and a color recording density for parts that are recorded using a chromatic color are set, the recording control unit produces a new lookup table by shifting values related to achromatic ink contained in the lookup table based on the set achromatic recording density and shifting values related to chromatic ink contained in the lookup table based on the set color recording density.

Because values related to the amount of achromatic ink in the lookup table are shifted based on a set achromatic recording density, and values related to the amount of chromatic ink are shifted based on a set color recording density, color shifting caused by disruption of the chromatic ink balance can be prevented, and achromatic ink can be effectively used to record sharp achromatic colors.

In another aspect of the invention, the recording control unit produces a new lookup table by shifting values related to achromatic ink and values related to chromatic ink that are contained in the lookup table, and shifting values related to achromatic colors that are rendered by combining chromatic inks based on the set achromatic recording density.

This aspect of the invention can produce a lookup table with appropriately set ink volume information for rendering achromatic colors by combining chromatic inks, and can therefore prevent color shifting of achromatic colors formed from a combination of chromatic inks.

Another aspect of the invention is a recording system including a recording device that records on a recording medium using chromatic and achromatic inks, and a recording control device that is connected to and controls the recording device. The recording control unit has a recording control unit that converts an image to be recorded to ink volume information using a lookup table for converting coordinate values of an input color model to ink volume information of an ink color model composed of a plurality of ink types including achromatic ink and chromatic ink, and causes the recording device to record the image to be recorded according to this ink volume information, and when a recording density for parts that are recorded on the recording medium using an achromatic color and a recording density for parts that are recorded using a chromatic color are set, produces a new lookup table based on these set density values and the values in the lookup table, and causes the recording device to record based on the produced new lookup table.

When the density of parts that are recorded using an achromatic color and the recording density of parts that are recorded using a chromatic color are set, this aspect of the invention generates a new lookup table based on these set values and records the image to be recorded using this new lookup table. As a result, the image can be quickly recorded according to the recording density settings without disturbing the balance between the different colors of ink.

In addition, because a lookup table is produced based on the density setting of the parts recorded in an achromatic color and the recording density setting of parts that are recorded in a chromatic color, the achromatic ink density can be adjusted appropriately and achromatic ink can be effectively used to record images even after adjusting the density.

Yet further, because a new lookup table for converting the image to an ink color space is produced, color shifts do not occur as easily as in a configuration that adjusts images in the input color model or adjusts the image after the image is converted using a lookup table.

Yet further, the load of the process for generating a new lookup table is less than the load of a process for correcting the image itself after conversion, and the density of the image can be quickly adjusted by converting the image using this newly produced lookup table.

In addition, because the ink volume values that are used when producing the new lookup table can be set with a high degree of freedom, the density of each color of ink can be adjusted with a high degree of freedom.

Another aspect of the invention is a recording control method including steps of: converting an image to be recorded to ink volume information using a lookup table for converting coordinate values of an input color model to ink volume information of an ink color model composed of a plurality of ink types including achromatic ink and chromatic ink; causing a recording device that records on a recording medium using chromatic and achromatic inks to record the image to be recorded according to this ink volume information; and producing a new lookup table based on set density values and the values in the lookup table and causing the recording device to record based on the produced new lookup table when a recording density for parts that are recorded on the recording medium using an achromatic color and a recording density for parts that are recorded using a chromatic color are set.

With the method according to this aspect of the invention, when the density of parts that are recorded using an achromatic color and the recording density of parts that are recorded using a chromatic color are set, this aspect of the invention generates a new lookup table based on these set values and records the image to be recorded using this new lookup table. As a result, the image can be quickly recorded according to the recording density settings without disturbing the balance between the different colors of ink.

In addition, because a lookup table is produced based on the density setting of the parts recorded in an achromatic color and the recording density setting of parts that are recorded in a chromatic color, the achromatic ink density can be adjusted appropriately and achromatic ink can be effectively used to record images even after adjusting the density.

Yet further, because a new lookup table for converting the image to an ink color space is produced, color shifts do not occur as easily as in a configuration that adjusts images in the input color model or adjusts the image after the image is converted using a lookup table.

Yet further, the load of the process for generating a new lookup table is less than the load of a process for correcting the image itself after conversion, and the density of the image can be quickly adjusted by converting the image using this newly produced lookup table.

In addition, because the ink volume values that are used when producing the new lookup table can be set with a high degree of freedom, the density of each color of ink can be adjusted with a high degree of freedom.

Another aspect of the invention is a program that causes a computer that controls a recording device that records on a recording medium using chromatic and achromatic inks to function as a recording control unit that converts an image to be recorded to ink volume information using a lookup table for converting coordinate values of an input color model to ink volume information of an ink color model composed of a plurality of ink types including achromatic ink and chromatic ink, causes the recording device to record the image to be recorded according to this ink volume information, and when a recording density for parts that are recorded on the recording medium using an achromatic color and a recording density for parts that are recorded using a chromatic color are set, produces a new lookup table based on these set density values and the values in the lookup table, and causes the recording device to record based on the produced new lookup table.

As a result of the computer executing this program, when the density of parts that are recorded using an achromatic color and the recording density of parts that are recorded using a chromatic color are set, this aspect of the invention generates a new lookup table based on these set values and records the image to be recorded using this new lookup table. As a result, the image can be quickly recorded according to the recording density settings without disturbing the balance between the different colors of ink.

In addition, because a lookup table is produced based on the density setting of the parts recorded in an achromatic color and the recording density setting of parts that are recorded in a chromatic color, the achromatic ink density can be adjusted appropriately and achromatic ink can be effectively used to record images even after adjusting the density.

Yet further, because a new lookup table for converting the image to an ink color space is produced, color shifts do not occur as easily as in a configuration that adjusts images in the input color model or adjusts the image after the image is converted using a lookup table.

Yet further, the load of the process for generating a new lookup table is less than the load of a process for correcting the image itself after conversion, and the density of the image can be quickly adjusted by converting the image using this newly produced lookup table.

In addition, because the ink volume values that are used when producing the new lookup table can be set with a high degree of freedom, the density of each color of ink can be adjusted with a high degree of freedom.

Another aspect of the invention is an information recording medium that stores the foregoing program. Examples of such an information recording medium include magnetic recording media such as floppy disks and hard disk drives; magneto-optical recording media such as MO discs; optical recording media such as CD-R, CD-RW, DVD±R, DVD±RW, and DVD-RAM media; recording devices that use semiconductor storage devices; and other types of recording media. The program can be recorded on such recording media in a format that can read by computer.

### EFFECT OF THE INVENTION

The invention enables recording images quickly and adjusting the density of different colors of ink with a high degree of freedom according to a set density level without disrupting the balance between different colors of ink by means of a low load process that can be executed quickly.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram of a recording system.

FIG. 2 is a block diagram describing the functions rendered by the printer driver.

FIG. 3 describes the recording control method of a host computer.

FIG. 4 is a flow chart describing the operation of the host computer.

FIG. 5 is a flow chart describing the density correction process in detail.

FIG. 6 is a table of specific values returned by the density correction process.

FIG. 7 is a graph describing correcting the density of a black point by means of the density adjustment algorithm.

FIG. 8 is a graph describing correcting color density by means of the density adjustment algorithm.

FIG. 9 is a flow chart describing a specific example of the density correction process.

### DESCRIPTION OF THE PREFERRED EMBODIMENTS

Preferred embodiments of the present invention are described below with reference to the accompanying figures.

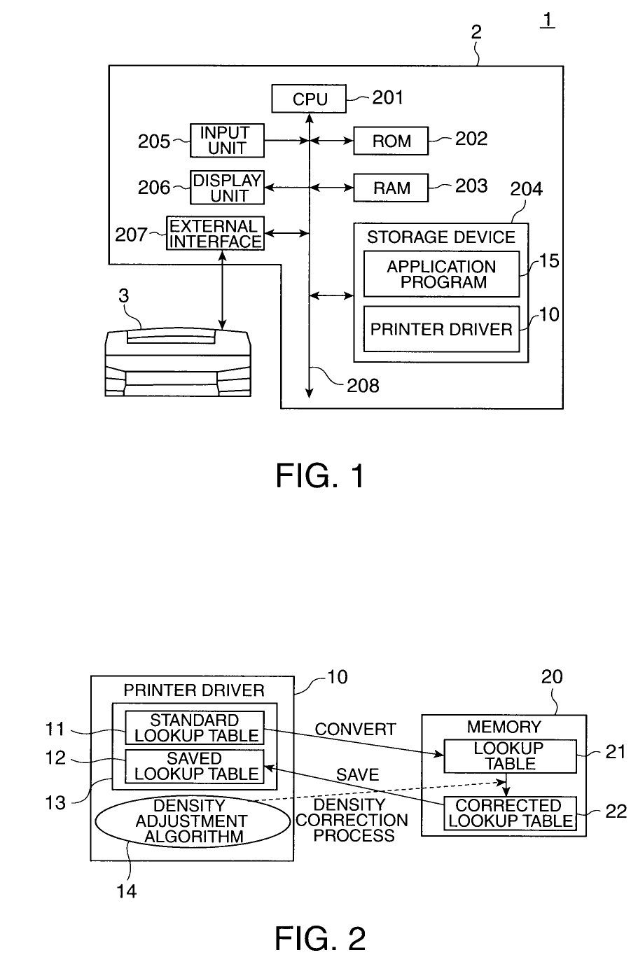

FIG. 1 is a block diagram showing the configuration of a recording system 1 according to a preferred embodiment of the invention. The recording system 1 shown in FIG. 1 has a printer 3 connected as an example of a recording device to a host computer 2 as an example of a recording control device.

The host computer 2 has a CPU 201 that executes a basic control program stored in ROM 202 to control the other parts of the host computer 2, ROM 202 that stores the basic control program, for example, that is executed by the CPU 201, RAM 203 that temporarily stores processed data and programs executed by the CPU 201, a storage device 204 that stores programs and data, an input unit 205 connected to an input device such as a keyboard or pointing device, a display unit 206 that controls displaying data on a display device (not shown in the figure), and an external interface 207 for connecting external peripherals to the host computer 2, and a bus 208 to which these various components are connected.

The CPU 201 reads and executes the basic control program stored in ROM 202 when the host computer 2 power is turned on, and initializes other parts of the host computer 2. Based on data input from the input unit 205, for example, the CPU 201 then reads and executes a program such as a printer driver 10 or application program stored in the storage device 204, and controls the operation of other parts of the host computer 2.

The storage device 204 is rendered by means of a magnetic or optical recording medium or semiconductor storage device, and non-volatilely stores programs such as the printer driver 10 and application program 15 that are executed by the CPU 201, and data associated with these programs.

The printer driver 10 is a program enabling the host computer 2 to control the printer 3 as described below, and includes information related to the data format and command types sent through the external interface 207 to the printer 3.

The application program 15 may be a software program for editing images or creating documents, for example, on the host computer 2.

An input device such as a keyboard or a pointing device such as a mouse or pen tablet is connected to the input unit 205. The input unit 205 detects operation of these input devices, and outputs data corresponding to the detected operation to the CPU 201.

A display device (not shown in the figure) such as a LCD panel is connected to the display unit 206, which outputs process results from the CPU 201 to the display device. For example, the display unit 206 displays images to be processed by the printer driver 10 described below, the operating status of the printer 3, and other information on the display device.

The external interface 207 includes a connector conforming to a particular standard such as USB or IEEE 1284 or an antenna for wireless communication, and an interface circuit appropriate to the connector or antenna. The external interface 207 is connected by wire or wirelessly to an external peripheral of the host computer 2, and enables communication between the host computer 2 and the peripheral devices.

The printer 3 is connected to the external interface 207 in this embodiment of the invention. The printer 3 is an inkjet printer that prints (records or forms) images by discharging four colors of ink, cyan (C), magenta (M), yellow (Y), and black (K), onto the recording surface of the recording medium, which may be a cut-sheet or continuous recording medium made of paper, non-woven cloth, or plastic, for example, to form dots of a chromatic or achromatic color.

The host computer 2 controls the printer 3 as a result of the CPU 201 executing the device driver 10, and causes the printer 3 to print an image, for example.

FIG. 2 is a block diagram schematically describing the functions rendered by the printer driver 10.

As shown in FIG. 2, the printer driver 10 is a driver program for controlling the printing operation of the printer 3, and, in addition to processing modules associated with drawing and color adjustment, has a resource 13 related to the correlation between color and ink volume. This resource 13 is rendered virtually by the CPU 201, RAM 203, and storage device 204 when the printer driver 10 executes, and two lookup tables, a standard lookup table 11 and a saved lookup table 12, are stored in the resource 13.

These lookup tables are tables that store the correlation between data describing an RGB image and data defining how much of each of plural different colors of ink is needed to express each color. These lookup tables are used to convert the RGB values of an image to the amount of each color of ink that the printer 3 must deposit on the recording medium to print the image.

When this printer driver 10 is executed, the CPU 201 of the host computer 2 functions as a recording control unit.

More specifically, using image data defined in the red (R), green (G), blue (B) color model, the host computer 2 expresses the color components of each pixel in a dot matrix as a gradation.

In the printing process of the printer 3, however, a process that converts the RGB image data to ink quantity values is required, and the converted ink volume values are obtained by an interpolation process based on a saved lookup table that correlates ink volumes to the RGB data in the image.

For example, because the printer 3 prints using four colors, specifically the chromatic ink colors cyan (C), magenta (M), and yellow (Y), and the achromatic ink color black (K), the lookup table stores the ink volumes [C, M, Y, K] for a particular color value (R, G, B values of the RGB color model). The lookup table may be configured as shown in Table 1 below, for example.

In Table 1, there is an n³ grid of CMYK values for an n grid of RGB values (the n grid of Table 1 means representative n points of color B values (256), and the n³ grid is calculated by multiplying three n grids of RGB). The host computer 2 can quickly retrieve the ink volume for a particular RGB value in the image by using such a lookup table. Note that because a lookup table addressing all RGB values quickly becomes very large, the ink volume values for some RGB values may be interpolated from the surrounding values in order to reduce the size of the data table.

TABLE 1

| | | [symbol] | [symbol] | [symbol] | [symbol] | [symbol] | [symbol] | [symbol] | | |
|---|---|---|---|---|---|---|---|---|---|---|
| | | [symbol] | [symbol] | [symbol] | 0 | 0 | 0 | 55 | | |
| n grid | {open oversize parenthesis} | | | | | | | | | |
| | | [symbol] | [symbol] | 5 | 5 | 5 | 5 | 55 | {close oversize parenthesis} | n³ grid |
| | | [symbol] | [symbol] | [symbol] | [symbol] | [symbol] | [symbol] | [symbol] | | |
| | {open oversize parenthesis} | | | | | | | | | |
| | | [symbol] | [symbol] | 55 | 50 | 50 | [symbol] | [symbol] | | |
| | | [symbol] | [symbol] | [symbol] | [symbol] | [symbol] | [symbol] | [symbol] | | |
| | | 55 | 55 | 55 | [symbol] | [symbol] | [symbol] | [symbol] | | |

[symbol]

indicates data missing or illegible when filed

The standard lookup table 11 is a lookup table that is predefined as a lookup table used by the printer driver 10. The printer driver 10 has a density adjustment algorithm 14 for correcting the print density based on user input. The lookup table corrected by the density adjustment algorithm 14 is stored in the resource 13 as a saved lookup table 12. More specifically, the printer driver 10 reads the standard lookup table 11 from the resource 13 and writes it to memory 20 based on user input. The memory 20 is a virtual temporary storage area that is constructed using RAM 203 (FIG. 1) and the storage device 204 (FIG. 1).

The standard lookup table 11 is written to memory 20 as lookup table 21. When the density correction process is executed according to the density adjustment algorithm 14 stored in the printer driver 10, the lookup table 21 is corrected and a corrected lookup table 22 is newly created. The corrected lookup table 22 is stored in the resource 13 as the saved lookup table 12, and can then be used when printing with the printer 3.

Note that the configurations shown in FIG. 2 are rendered by the cooperation of hardware components such as the CPU 201 of the host computer 2 and software components such as the printer driver 10 and the application program 15. The process described below as an operation of the printer driver 10 shown in FIG. 2 is rendered by the CPU 201 executing a program. It will therefore be obvious that the operation of the printer driver 10 is not dependent solely on specific hardware or specific software, and is achieved by installing the printer driver 10 on a common computer that is connected to the printer 3 and functions as the host computer 2 described herein.

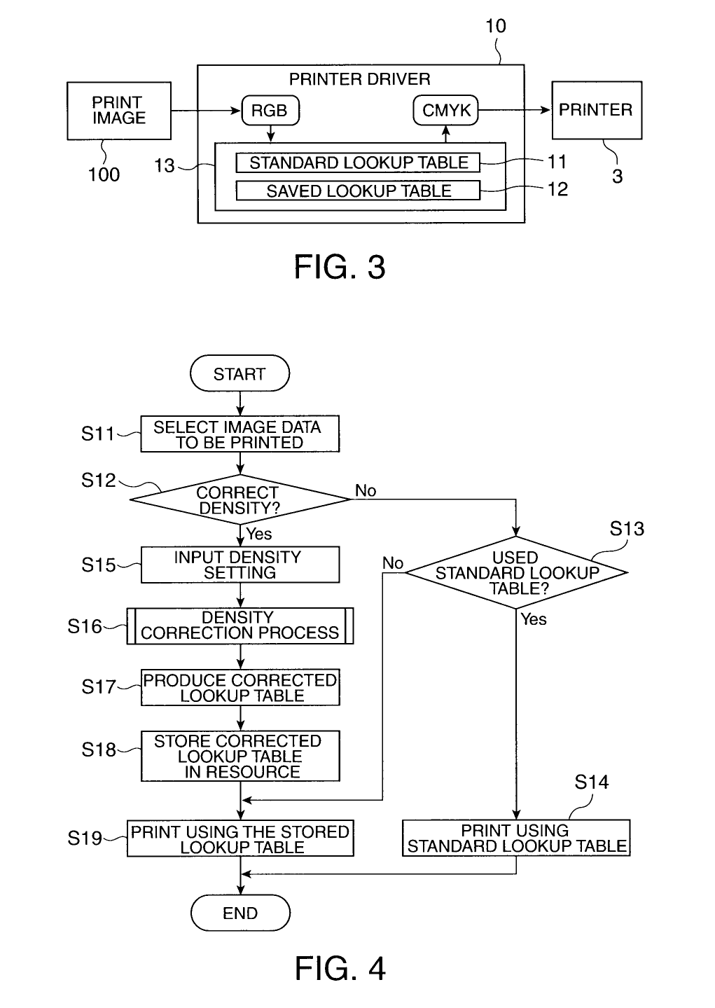

FIG. 3 describes the recording control method executed by the host computer 2.

As shown in FIG. 3, the recording system 1 acquires the image 100 to be printed (referred to as the “print image 100” below) by means of the printer driver 10, converts the RGB values to CMYK values indicating the ink volume using the standard lookup table 11 or saved lookup table 12 of the resource 13, and outputs the post-conversion values to the printer 3. An image 100 is printed as a result.

The recording control method of the recording system 1 is described next.

FIG. 4 is a flow chart showing the steps in the recording control method executed by the host computer 2 in this embodiment of the invention.

An image 100 to be printed that is created using a desired application or is acquired from another device by the host computer 2 is first selected (step S11), and whether or not to correct the print density is decided (step S12). In steps S11 and S12 the print image 100 is selected and whether or not to correct the print density is determined by the user using the input unit 205, for example.

If the print density is not corrected (step S12 returns No), whether or not to print using the standard lookup table 11 is decided (step S13). Whether or not to use the standard lookup table 11 is determined by input through the input unit 205 in step S13, for example.

If the standard lookup table 11 is used (step S13 returns Yes), the CPU 201 determines the ink volumes from the RGB values of the print image 100 based on the standard lookup table 11, and outputs the obtained ink volume values to the printer 3 to print the image 100 on the printer 3 (step S14). The process then ends.

If the standard lookup table 11 is not used (step S13 returns No), the printer driver 10 executes step S19 to obtain the ink volume values from the RGB values of the print image 100 based on the saved lookup table 12, and output the obtained ink volume values to the printer 3 to print the print image 100 on the printer 3 (step S14). The process then ends.

However, if the print density is to be corrected (step S12 returns Yes), the density settings are input by the user through the input unit 205, for example (step S15).

In this embodiment of the invention a setting for the print density of black dots (black dot density or achromatic color recording density) and a setting for the color print density (color density or color recording density) are input separately in step S15.

The setting for the print density of black dots determines the print density of areas composed of only black dots that are formed on the recording surface of the recording medium by the printer 3, and corresponds to the density of black dots rendered using black (K) ink, and the density of black dots that are formed by mixing three colors of ink (CMY) (referred to below as composite black or comK). The color print density setting is the correction setting for the density of colors that are formed by mixing three colors of ink (CMY).

The black and color print density settings may be set in nine levels ranging from 1 to 9, and the user can select the desired level from 1 to 9. If the median value of 5 in this range from 1 to 9 is the zero correction level, the density can be increased or decreased as desired.

Messages prompting the user to input the density setting or a screen for inputting density settings are displayed by the display unit 206 in step S15, and the user operates the input unit 205 as prompted by the on-screen display to input the desired values.

The CPU 201 then executes the density correction process according to the density adjustment algorithm 14 (FIG. 2) (step S16), corrects the values of the lookup table 21 generated in memory 20 from the standard lookup table 11, and produces the corrected lookup table 22 (step S17). The CPU 201 then stores the corrected lookup table 22 as the saved lookup table 12 in the resource 13 (step S18), executes step S19 to acquire the ink volume values from the RGB values of the print image 100 based on the saved lookup table 12, outputs the acquired ink volume values to the printer 3 so that the printer 3 prints the print image 100, and then ends this process.

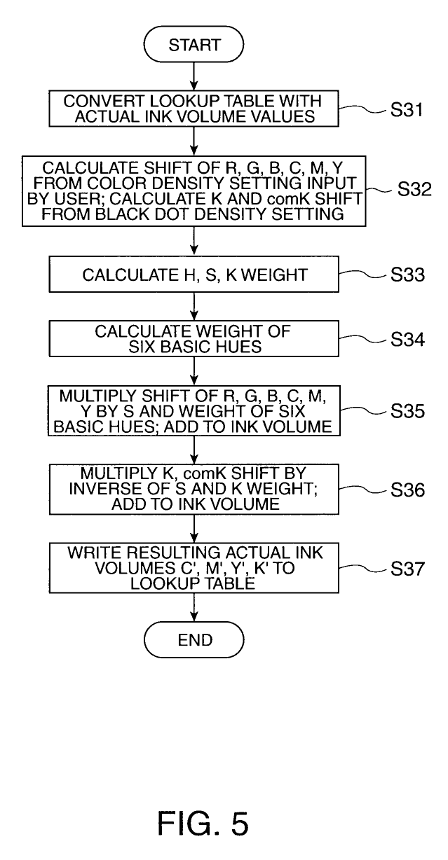

FIG. 5 is a flow chart describing the density correction process executed as step S16 in FIG. 4 in detail.

In the density correction process shown in FIG. 5 the CPU 201 converts the standard lookup table 11 to actual ink volume values by running the printer driver 10 (step S31).

The CPU 201 then calculates the shift of the R, G, B, C, M, and Y values from the color density settings input by the user in step S15 (FIG. 4), and calculates the shift of the black (K) and comK values from the black dot density setting (step S32).

The CPU 201 calculates this shift in step S32 as described below.

If the black density setting that is input in step S15 (FIG. 4) is x and the color density setting is y, x and y are set to one of nine values in the range 1 to 9 where the median value (5) is the default and corresponds to the value in the lookup table 21.

The shift in the R, G, B, C, M, Y values is calculated from the equations (1) to (8) below.

Note, however, that in equations (1) to (8) the total ink volume is the total actual volume of all colors of ink retrieved from the lookup table 21 that render a particular color. For example, the total ink volume for the RGB value (255, 0, 0) is the sum of the CMYK ink volumes corresponding to the color represented by the RGB value (255, 0, 0).

The maximum ink volume in equations (1) to (8) is the maximum amount of ink that can be discharged by the printer 3 when forming a particular color. For example, the maximum R ink volume is the total of the maximum amount of ink that can be discharged when ink is discharged to form the color red (R). Because red (R) is produced by combining yellow (Y) and magenta (M) inks, the maximum R ink volume is 200% of the maximum amount of one color of ink where the maximum amount of yellow (Y) ink is 100% and the maximum amount of magenta (M) ink is 100%. Likewise, the maximum G ink volume is 200%, combining the maximum amount of yellow (Y) and cyan (C) inks used to form green (G), and the maximum B ink volume is 200%, combining the maximum amount of cyan (C) and magenta (M) inks used to form blue (B). In addition, the maximum C ink volume is 100% of the maximum amount of dischargeable cyan (C) ink, the maximum M ink volume is 100% of the maximum amount of magenta (M) ink, the maximum Y ink volume is 100% of the maximum amount of yellow (Y) ink, and the maximum K ink volume is 100% of the maximum amount of black (K) ink. The total maximum ink volume denotes the maximum comK ink volume, and is 400%, that is, the sum of the maximum 100% of the four CMYK inks that can be deposited to form composite black.

R shift=(maximum R ink volume−total ink volume for (R,G,B=255,0,0))×(y−5)/4 (1)

G shift=(maximum G ink volume−total ink volume for (R,G,B=0,255,0))×(y−5)/4 (2)

B shift=(maximum B ink volume−total ink volume for (R,G,B=0,0,255))×(y−5)/4 (3)

C shift=(maximum C ink volume−total ink volume for (R,G,B=0,255,255))×(y−5)/4 (4)

M shift=(maximum M ink volume−total ink volume for (R,G,B=255,0,255))×(y−5)/4 (5)

Y shift=(maximum Y ink volume−total ink volume for (R,G,B=255,255,0))×(y−5)/4 (6)

K shift=(maximum K ink volume−K ink volume for(R,G,B=0,0,0))×(x−5)/4 (7)

comK shift=(total maximum ink volume−maximum K ink volume−ink volume not including K for(R,G,B=0,0,0))×(x−5)/4 (8)

In equations (1) to (8) 5 is subtracted from x and y because x and y can be set to one of nine values from 1 to 9 and 5 is the median in this range.

The color shift of R, G, B, C, M, Y, K, and comK can be quickly calculated from equations (1) to (8) based on the difference between the maximum ink volume and the ink volume retrieved from the data grid in lookup table 21. In addition, by separately determining the shift in composite black (comK) and the shift in black rendered by black ink (K), the correction to be applied in a printer 3 that can render both composite black and black using black (K) ink can be accurately and appropriately determined.

It will be obvious to one with ordinary skill in the related art that the method of calculating the shift in each color is not limited to the method described in equations (1) to (8). The user is also not limited to a method of setting the color density and setting the black dot density, and a configuration in which the density of composite black and the K shift in the setting of black dots formed by black (K) ink are set separately is also conceivable. In this configuration the K shift and the comK shift can be accurately calculated more quickly.

Next, the CPU 201 calculates the hue (H in a HSV color space), saturation (S in a HSV color space), and K weight (UCR) from the RGB values in the standard lookup table 11 (step S33).

The CPU 201 then determines the weight of the six basic hues (H_R, H_Y, H_G, H_C, H_B, H_M) from the H values calculated in step S33 (step S34).

The CPU 201 then multiplies the R, G, B, C, M, Y shift values obtained in step S32 by the weight of the six basic hues obtained in step S34, and adds the result to the ink volume values obtained in step S31 (step S36).

The ink volume values obtained through step S35 and step S36 are then set as the values of the lookup table to output corrected lookup table 22 (step S37).

The CPU 201 thus functions as a density adjustment unit by applying the density correction process using the density adjustment algorithm 14, shifts the values of the lookup table 21 obtained by writing the standard lookup table 11 into memory 20, and produces the new lookup table 22.

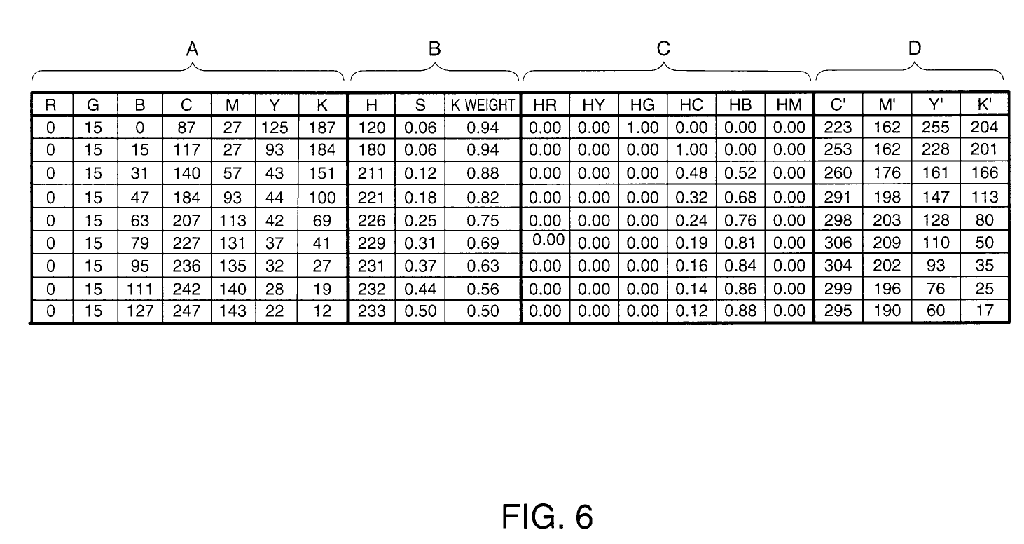

FIG. 6 is a table showing specific examples of the values returned by the density correction process described in FIG. 5.

As shown by A in FIG. 6, the RGB values stored in the lookup table 21 are converted to CMYK ink volume values in step S31.

The hue, saturation, and K weight are then calculated in step S33 as indicated by B in FIG. 6, and the weights of the six basic hues (H_R, H_Y, H_G, H_C, H_B, H_M) are then calculated in step S34 as indicated by C in FIG. 6.

In step S35, the weights of the six basic hues are then multiplied by the shift in R, G, B, C, M, and Y, and the results are added to the ink volumes shown under A. In step S36, the product of the K weight and the inverse of the saturation value shown in B times the shift in K and comK is added to the ink volume shown in A to obtain the new ink volume values C′, M′, Y′, K′ shown under D in FIG. 6. These new ink volume values C′, M′, Y′, K′ are set for the R, G, and B values of the initial lookup table 21 shown under A to output the corrected lookup table 22.

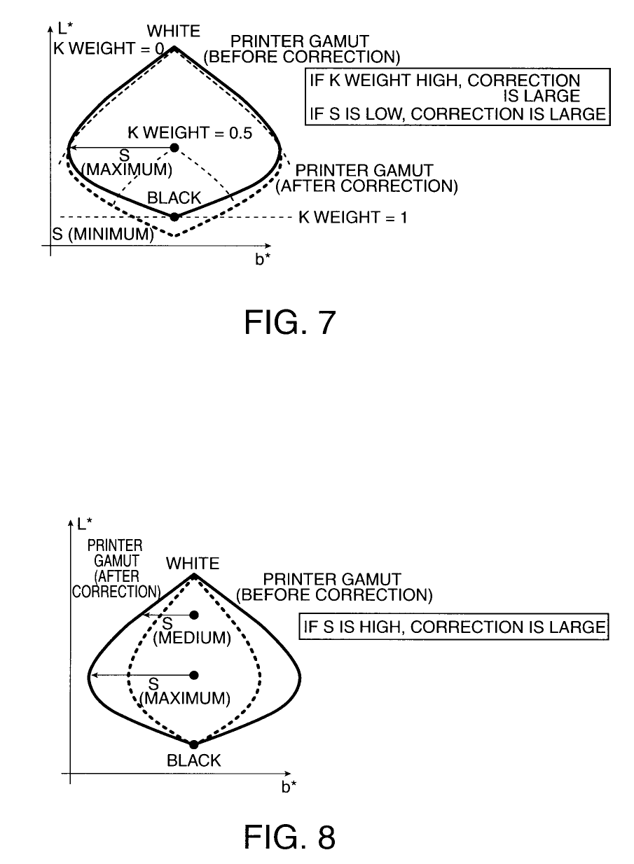

FIG. 7 describes correcting the black dot density using the density adjustment algorithm 14 described above, and FIG. 8 describes correcting the color density using the density adjustment algorithm 14.

It will be obvious from the change in the printer gamut shown in FIG. 7 that density correction increases as the saturation S decreases, and correction increases as the K weight increases (there is no correction of white, that is, the K weight=0). It will also be known from the change in printer gamut shown in FIG. 8 that all ink volumes are corrected.

A specific example of ink volume correction using the foregoing density adjustment algorithm 14 is described next.

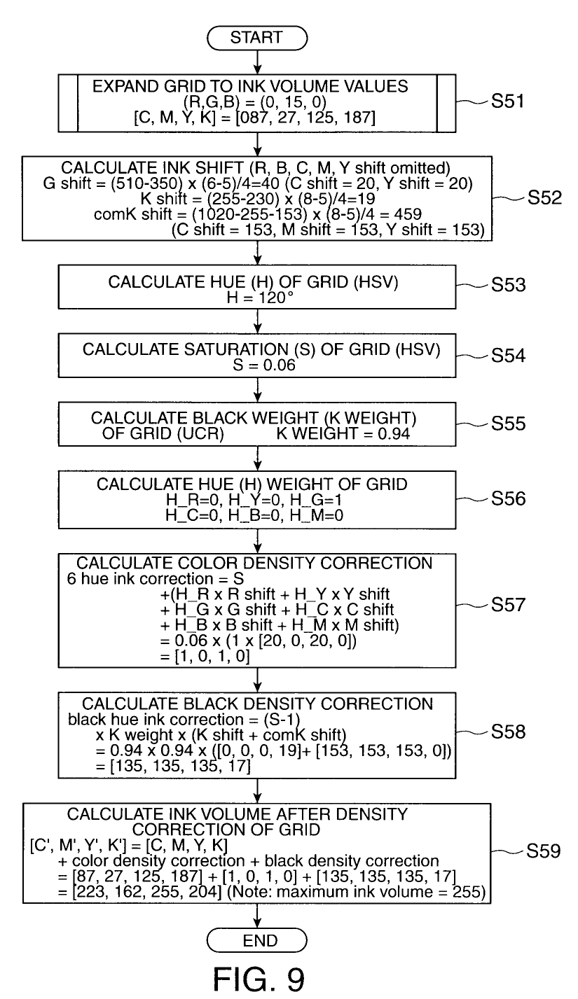

FIG. 9 is a flow chart showing a specific example of the density correction process described above with reference to the flow chart in FIG. 5, and describes the process when applied to (R,G,B)=(0, 15, 0) with user settings of 8 for the black dot print density and 6 for the color print density.

The CPU 201 first converts ((R,G,B)=(0, 15, 0)) to ([C, M, Y, K]=[087, 27, 125, 187]) (step S51).

Next, the CPU 201 calculates the shift in each color of ink based on the black dot print density setting (x=8) and color print density setting (y=6) (step S52).

More specifically, the shift in R, G, B, C, M, Y, K, and comK is calculated based on the foregoing equations (1) to (8).

For example, based on the foregoing equation (2), the green (G) shift is determined to be (maximum G ink volume (510)−total ink volume for (R,G,B=0,255,0) (350))×(6-5)/4=40.

Similarly, based on the foregoing equation (7), the black (K) shift is determined to be (maximum K ink volume (255)−K ink volume for (R,G,B=0,0,0) (230))×(8-5)/4=19.

Based on equation (8), the comK shift is determined to be (total maximum ink volume (1020)−maximum K ink volume (255)−ink volume not including K for (R,G,B=0,0,0) (153)) 33 (8-5)/4=459.

Based on a HSV formula, the CPU 201 then calculates the hue (H=120°) of the grid (step S53) and calculates the saturation (S=0.06) of the grid (step S54), and based on a UCR formula calculates the black weight (K weight=0.94) of the grid (step S55).

The CPU 201 then calculates the hue (H) weight of the grid (step S56). More specifically, H=120° is separated into the weight of the six basic hues. In this example H_R=0, H_Y=0, H_G=1, H_C=0, H_B=0, H_M=0.

Based on the shift of each color R, G, B, C, M, Y calculated in step S52, the CPU 201 then calculates the color density correction (step S57) as shown below.

6 hue ink correction=S×(H_{—}R×R shift+H_{—}Y×Y shift+H_{—}G×G shift+H_{—}C×C shift+H_{—}B×B shift+H_{—}M×M shift)=0.06×(1×[20,0,20,0])=[1,0,1,0]

Next, the CPU 201 calculates the black density correction based on the K shift and comK shift calculated in step S52 (step S58). The equation for this calculation is shown next.

black hue ink correction=(S−1)×K weight×(K shift+comK shift)=0.94×0.94×([0,0,0,19]+[153,153,153,0])=[135,135,135,17]

The CPU 201 then calculates the ink volume after density correction of the corresponding grid (step S59).

If the ink volume before density correction is [C, M, Y, K], and the ink volume after density correction is [C′, M′, Y′, K′], the following equation can be used.

$$\begin{matrix}[ {C}^{′} , {M}^{′} , {Y}^{′} , {K}^{′} ] = [ C , M , Y , K ] + color density correction + \\ black density correction \\ = [ 87 , 27 , 125 , 187 ] + [ 1 , 0 , 1 , 0 ] + \\ [ 135 , 135 , 135 , 17 ] \\ = [ 223 , 162 , 255 , 204 ]\end{matrix}$$

With the recording system 1 according to the embodiment of the invention described above, a host computer 2 that is connected to and controls a printer 3 that prints on a recording medium using the four ink colors CMYK functions as a recording control unit as a result of the CPU 201 running a printer driver 10, converts an image to be printed to ink volume values using a standard lookup table 11 for converting the coordinate values in the color model of the input print image 100 to the ink volume values of a CMYK ink color model, and records the image to be printed by means of the printer 3 according to these calculated ink volume values.

When the user has set the print density, the CPU 201 executes a density correction process according to a defined density adjustment algorithm 14 using a function of the printer driver 10, and when the black dot recording density (achromatic color recording density) of parts that are printed on the recording medium using black, that is, an achromatic color, and the color recording density of parts that are recorded using a chromatic color, are set, generates a new saved lookup table 12 based on these set values and a standard lookup table 11, and prints by means of the printer 3 based on the new saved lookup table 12. As a result, the image can be printed quickly according to the set print density without disturbing the balance between the different colors of ink.

In addition, because a saved lookup table 12 is generated and saved based on the black dot density setting and the color density setting, the density of black (K) ink can be appropriately adjusted, and after the density is adjusted, crisp black colors can be recorded after the density is adjusted while efficiently using black (K) ink.

Furthermore, because sharply defined barcodes can be printed using black (K) ink and composite black with no color shifting when this recording system 1 is used to print barcodes, the resulting barcodes can be read with a high recognition rate by a barcode reader. Yet further, because the recording system 1 according to this embodiment of the invention creates a new saved lookup table 12 for converting the image 100 to be printed to an ink color space, the recording system 1 is resistant to color shifting and can better prevent a drop in throughput compared with systems that adjust the RGB values of the print image 100 and create new RGB values, or adjust color values after conversion to an ink color model.

The process that produces the saved lookup table 12 in this recording system 1 imposes a lighter load on the processor than processes that correct the image itself after conversion to CMYK using a lookup table, and can quickly adjust the image density by converting the image using this new saved lookup table 12.

Furthermore, there is a high degree of freedom in determining the ink volume values that are set when producing the saved lookup table 12, and the density of individual CMYK colors can be separately adjusted by using a lookup table that converts the coordinate values of the input color space to the ink volume values of the four ink colors CMYK as described in this embodiment of the invention. As a result, even if the black (K) ink density is set to the maximum, the composite black (comK) density can be increased to increase the print density of black, and the density of each color of ink can be adjusted with a high degree of freedom.

Furthermore, when the black dot print density of parts that are recorded with an achromatic color on the recording medium and the color print density of parts that are recorded with a chromatic color are set, the printer driver 10 of this recording system 1 shifts the black (K) ink values contained in the standard lookup table 11 (lookup table 21) based on the black dot print density and shifts the CMY ink values contained in the standard lookup table 11 (lookup table 21) based on the color print density, and thereby produces the corrected lookup table 22. As a result, color shifting caused by the chromatic ink balance being changed can be prevented, and sharp black hues can be recorded by using achromatic ink effectively.

In addition, the corrected lookup table 22 can be generated and color shifting of composite black can be reliably prevented in this recording system 1 as a result of the printer driver 10 shifting the black (K) ink values and CMY ink values contained in the standard lookup table 11 (lookup table 21), and shifting the values related to composite black comK formed by blending CMY inks based on the black dot print density.

The foregoing embodiment describes a configuration that executes the process shown in FIG. 4 and FIG. 5 by running a printer driver 10 stored in the storage device 204 of the host computer 2, but a configuration in which the printer driver 10 is sent and the foregoing settings are sent to the host computer 2 from another externally connected device through the external interface 207 or a communication circuit is also conceivable.

Yet further a configuration in which the printer 3 is directly connected to the host computer 2 is described above, but the invention is not so limited. For example, a configuration that controls the printer 3 to print by sending data from the host computer 2 to the printer 3 over a communication line, or sending data from a host computer 2 to another computer connected to the printer 3, is also conceivable.

Yet further, an inkjet printer 3 that prints images using the four ink colors CMYK is described above, but the number and types of inks used is not so limited, and the invention can obviously be applied to six-color printers that complement the four ink colors CMYK with two additional light ink colors, as well as to other printers that use even more colors of ink.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A recording control device that is connected to and controls a recording device that records on a recording medium using chromatic and achromatic inks, the recording control device comprising:
a recording control unit that converts an image to be recorded to ink volume information using a lookup table for converting coordinate values of an input color model to ink volume information of an ink color model composed of a plurality of ink types including achromatic ink and chromatic ink, and causes the recording device to record the image to be recorded according to this ink volume information, and
when a recording density for parts that are recorded on the recording medium using an achromatic color and a recording density for parts that are recorded using a chromatic color are set, produces a new lookup table based on these set density values and the values in the lookup table, and causes the recording device to record based on the produced new lookup table.

2. The recording control device described in claim 1, wherein:
when an achromatic recording density for parts that are recorded on the recording medium using an achromatic color and a color recording density for parts that are recorded using a chromatic color are set, the recording control unit produces a new lookup table by shifting values related to achromatic ink contained in the lookup table based on the set achromatic recording density and shifting values related to chromatic ink contained in the lookup table based on the set color recording density.

3. The recording control device described in claim 2, wherein:
the recording control unit produces a new lookup table by shifting values related to achromatic ink and values related to chromatic ink that are contained in the lookup table, and shifting values related to achromatic colors that are rendered by combining chromatic inks based on the set achromatic recording density.

4. A recording system comprising:
a recording device that records on a recording medium using chromatic and achromatic inks; and
a recording control device that is connected to and controls the recording device, and has
a recording control unit that converts an image to be recorded to ink volume information using a lookup table for converting coordinate values of an input color model to ink volume information of an ink color model composed of a plurality of ink types including achromatic ink and chromatic ink, and causes the recording device to record the image to be recorded according to this ink volume information, and
when a recording density for parts that are recorded on the recording medium using an achromatic color and a recording density for parts that are recorded using a chromatic color are set, produces a new lookup table based on these set density values and the values in the lookup table, and causes the recording device to record based on the produced new lookup table.

5. The recording system described in claim 4, wherein:
when an achromatic recording density for parts that are recorded on the recording medium using an achromatic color and a color recording density for parts that are recorded using a chromatic color are set, the recording control unit produces a new lookup table by shifting values related to achromatic ink contained in the lookup table based on the set achromatic recording density and shifting values related to chromatic ink contained in the lookup table based on the set color recording density.

6. The recording system described in claim 4, wherein:
the recording control unit produces a new lookup table by shifting values related to achromatic ink and values related to chromatic ink that are contained in the lookup table, and shifting values related to achromatic colors that are rendered by combining chromatic inks based on the set achromatic recording density.

7. A recording control method comprising steps of:
converting an image to be recorded to ink volume information using a lookup table for converting coordinate values of an input color model to ink volume information of an ink color model composed of a plurality of ink types including achromatic ink and chromatic ink;
causing a recording device that records on a recording medium using chromatic and achromatic inks to record the image to be recorded according to this ink volume information; and
producing a new lookup table based on set density values and the values in the lookup table and causing the recording device to record based on the produced new lookup table when a recording density for parts that are recorded on the recording medium using an achromatic color and a recording density for parts that are recorded using a chromatic color are set.

8. The recording control method described in claim 7, comprising a step of:
producing a new lookup table by shifting values related to achromatic ink contained in the lookup table based on a set achromatic recording density and shifting values related to chromatic ink contained in the lookup table based on a set color recording density when an achromatic recording density for parts that are recorded on the recording medium using an achromatic color and a color recording density for parts that are recorded using a chromatic color are set.

9. The recording control method described in claim 8, comprising a step of:
producing a new lookup table by shifting values related to achromatic ink and values related to chromatic ink that are contained in the lookup table, and shifting values related to achromatic colors that are rendered by combining chromatic inks based on the set achromatic recording density.
